(19) United States
(12) Patent Application Publication
(10) Pub. No.: US 2010/0238428 A1
(43) Pub. Date: Sep. 23, 2010

(54) METHOD FOR DETECTING FIBER OPTIC FIBERS AND RIBBONS

(75) Inventors: Michael Glines, Laconia, NH (US); Jianxum Fang, Concord, NH (US); Christopher Blair, Canterbury, NH (US)

Correspondence Address: SUGHRUE MION, PLLC, 2100 PENNSYLVANIA AVENUE, N.W., SUITE 800, WASHINGTON, DC, 20037, US

(73) Assignee: AFL TELECOMMUNICATIONS LLC, Spartanburg, SC (US)

(21) Appl. No.: 12/441,652

(22) PCT Filed: Jun. 9, 2008
(86) PCT No.: PCT/US08/66313

§ 371 Date: Mar. 17, 2009

Related U.S. Application Data
(60) Provisional application No. 60/942,569, filed on Jun. 7, 2007.

(51) Int. Cl. G01N 21/00

(52) U.S. Cl. 356/73.1

(57) ABSTRACT

A method of identifying or tracing one of a plurality of fiber optic fibers including transmitting a plurality of fiber identification data signals into ends of a plurality of fiber optic fibers, wherein a different data signal is transmitted to each of the plurality of fiber optic fibers; and identifying one of the plurality of fiber optic fibers based on the signal transmitted on the one fiber; wherein the data signals are digital codes.

### CROSS-REFERENCE TO RELATED APPLICATIONS

This application claims priority from U.S. Provisional Application No. 60/942,569 filed on Jun. 7, 2007, the disclosure of which is incorporated herein by reference.

### BACKGROUND OF INVENTION

1. Field of Invention

Methods consistent with the present invention relate to a method of detecting and identifying fiber optic fibers and ribbons. More particularly, the present invention relates to a method of fiber optic ribbons by detecting a unique digital code in an optical fiber.

2. Description of the Related Art

Optical Fiber Identifiers or OFIs operate by bending a buffered or jacketed optical fiber and measuring any light that escapes as the result of the controlled bend. When used for fiber identification, traditional OFIs require that one end of the fiber to be identified be connected to a source that can generate an optical signal modulated at one of several frequencies, from about 270 Hz to 2 kHz, commonly used for fiber identification. Because normal traffic on an optical fibers used in telecommunications systems contains little power at these relatively low frequencies, an OFI can determine whether a fiber, ribbon, jumper, or pigtail is dark, carrying (live) traffic, or carrying a tone.

Similarly, Optical Power Meters or OPMs may be designed to indicate whether fibers are dark, carrying traffic, or carrying identification tones, by connecting them to these fibers at cable termination points, typically central office optical patch panels or FTTH fiber distribution hubs (FDH).

One limitation of current optical fiber identification techniques is that the source can only be connected to one fiber at a time. Thus, if a splicing technician wants to identify multiple fibers to be spliced at a mid-span location, they must either work with second technician at one end of the span, set up multiple sources with (each set to a different frequency) or travel to the end of the span where the source is located before each fiber is spliced.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

One method of identifying one of a plurality of fiber optic fibers includes transmitting a plurality of fiber identification data signals into ends of a plurality of fiber optic fibers, wherein a different data signal is transmitted to each of the plurality of fiber optic fibers; and identifying one of the plurality of fiber optic fibers based on the signal transmitted on the one fiber; wherein the data signals are digital codes.

The method may further include the identification occurring at a controlled bend in the one of the plurality of fibers.

In the method, the plurality of fibers could be part of a fiber optic cable.

The method may further include the data signals being transmitted in return to zero format.

The method may further include the data signals being transmitted into the plurality of fibers one at a time.

The method may further include the identification occurring at a termination point of the one of the plurality of fibers.

Another method includes identifying one of a plurality of fiber optic ribbons by transmitting a plurality of fiber identification data signals into ends of one fiber in each of the plurality of fiber optic ribbons, wherein a different data signal is transmitted to the one fiber in each of the plurality of fiber optic ribbons; and identifying one of the plurality of fiber optic ribbons based on the signal transmitted on the one fiber; wherein the data signals are digital codes.

The method may further include the identification occurring at a controlled bend in said one of the plurality of ribbons.

The method may further include the data signals being transmitted in return to zero format.

The method may further include the data signals being transmitted into the one fiber in the plurality of ribbons one at a time.

The method may further include the identification occurring at a termination point of the one of the plurality of ribbons.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 illustrates an embodiment of the multifiber tracer.

FIG. 2 illustrates an embodiment of the multifiber identifier.

FIG. 3 illustrates an embodiment of the multifiber identifier being used with the multifiber tracer.

FIGS. 4 and 5 illustrates applications where the MFT and MFI can be used.

FIG. 6 illustrates an embodiment of the data burst stagger bit patter for four of the twelve lasers.

FIG. 7 illustrates an embodiment of the data burst stagger timing for the twelve lasers.

FIG. 8 illustrates an embodiment of the multifiber identifier.

FIG. 9 illustrates an embodiment of the multifiber tracer.

FIG. 10 illustrates a typical FTTx PON layout.

FIGS. 11 and 12 illustrate the use of an OPM to identify fibers at the end point of a fiber.

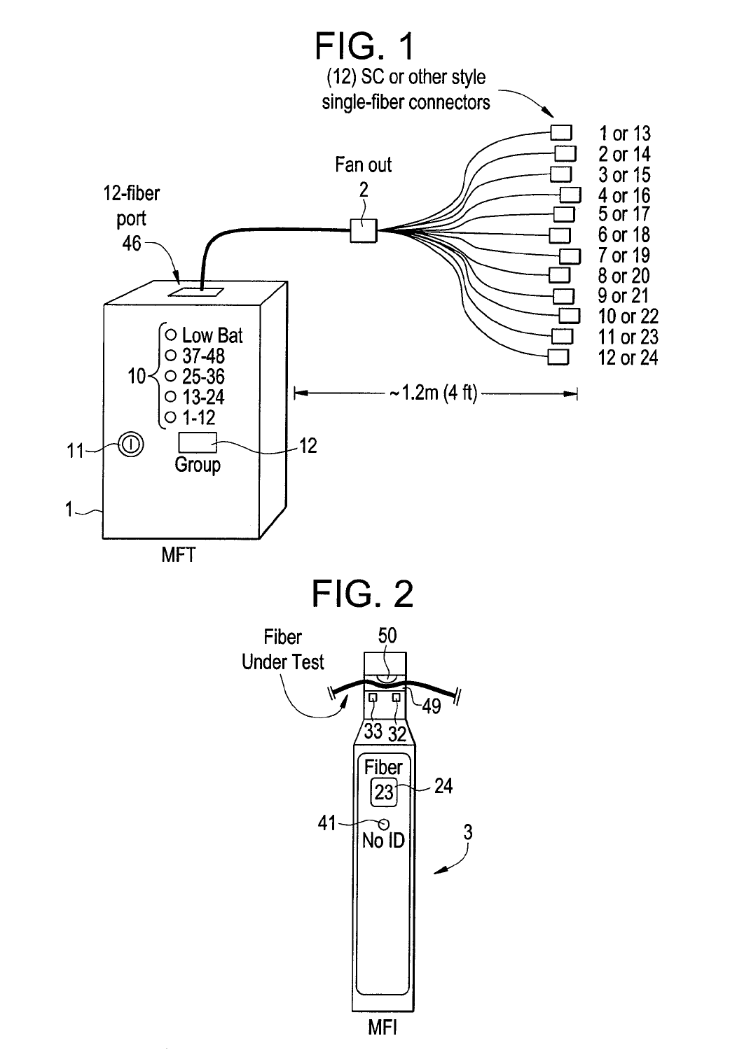

### DETAILED DESCRIPTION OF EXEMPLARY EMBODIMENTS OF THE INVENTION

Hereinafter, exemplary embodiments of the present invention will be described with reference to the accompanying drawings.

An exemplary Multifiber Tracer (MFT) 1 is a single port (MPO-type) twelve fiber output 1550 nm source. It is designed around twelve discrete laser sources (that can be, for example, 1550 nm single mode) tied into an MPO fan-out connector 2. The MFT 1 can be packaged, for example, in a Pactec LH45-100 style case. The MFT has a keypad. All calibration and operation can be performed via the keypad. Additionally, calibration can be controlled via an onboard USB port. The unit can be powered by 2 AA alkaline or NiMH batteries or an AC adapter.

The MFT 1 generates a digital code by using a unique data burst for each individual fiber, which is transmitted from the test port and is which is used to automatically identify the fiber under test. This feature is used in conjunction with a Multi-Fiber Identifier (MFI) 3 to provide automatic fiber identification.

Fiber Identification: A fiber identification data burst mode is the default operating mode of the MFT 1. Unlike the conventional devices, such as the Noyes OLSx series, the only time a given laser is active is when it is transmitting the fiber ID data burst. In one embodiment, the MFT 1 is capable of generating identifications (IDs) for up to 48 fibers, in groups of twelve (1-12, 13-24, 25-36, or 37-48). The protocol used by the MFT 1 and MFI 3 for fiber identification is described below. The ID data burst consists of a start bit 25 (2.5 bits wide), followed by 8 bits 26 configured to provide up to 48 individual fiber ID codes. The data is sent in RZ (Return to Zero) format. The most significant bit (MSB) and least significant bit (LSB) will always be logic ‘1’. The data bursts are staggered such that no two lasers will be transmitting at the same time. The data burst on each individual fiber will repeat 8 times per second. Examples of bit patterns for two groups of twelve fiber is below. Other bit patterns could be used. However, a specific bit pattern that avoids false detection of normal data traffic (e.g., in an interoffice network or FTTH application).

| | | |
|---|---|---|
| Fiber # | ID Data | Bit Pattern |

Group 1 (1-12)

| | | |
|---|---|---|
| 1 | 0xFF | 11111111 |
| 2 | 0xFD | 11111101 |
| 3 | 0xFB | 11111011 |
| 4 | 0xF7 | 11110111 |
| 5 | 0xEF | 11101111 |
| 6 | 0xDF | 11011111 |
| 7 | 0xBF | 10111111 |
| 8 | 0xF9 | 11111001 |
| 9 | 0xF3 | 11110011 |
| 10 | 0xE7 | 11100111 |
| 11 | 0xCF | 11001111 |
| 12 | 0x9F | 10011111 |

| | | |
|---|---|---|
| Fiber # | ID Data | Bit Pattern |

Group 2 (13-24)

| | | |
|---|---|---|
| 13 | 0xF5 | 11110101 |
| 14 | 0xED | 11101101 |
| 15 | 0xDD | 11011101 |
| 16 | 0xBD | 10111101 |
| 17 | 0xEB | 11101011 |
| 18 | 0xDB | 11011011 |
| 19 | 0xBB | 10111011 |
| 20 | 0xD7 | 11010111 |
| 21 | 0xB7 | 10110111 |
| 22 | 0xAF | 10101111 |
| 23 | 0x71 | 11110001 |
| 24 | 0xE3 | 11100011 |

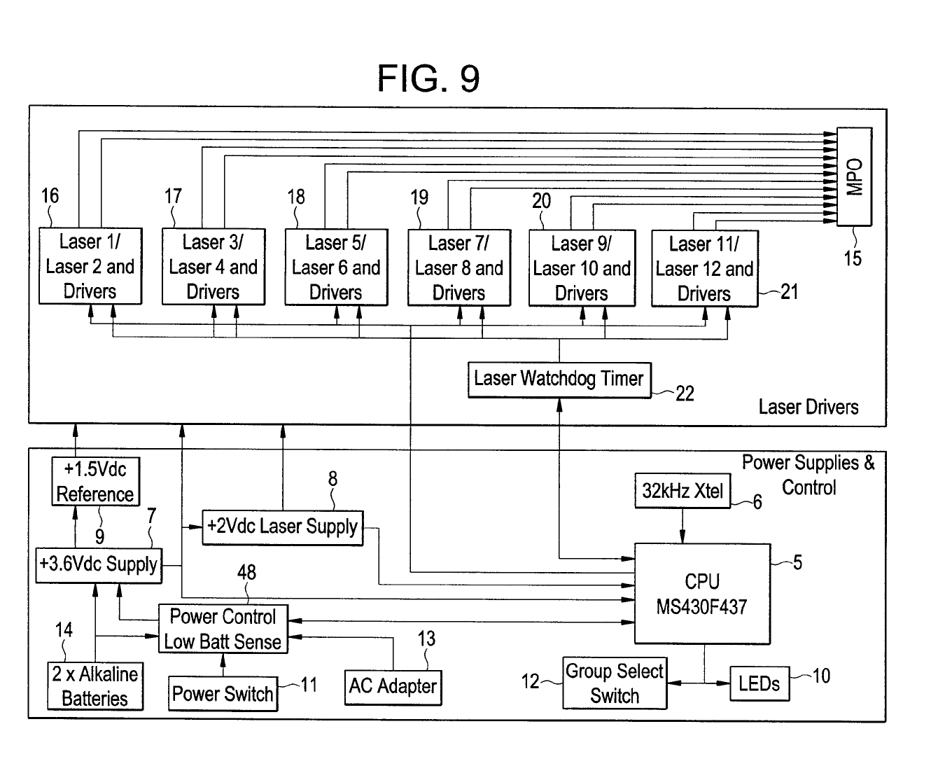

As shown in FIG. 9, one embodiment of an MFT consists of two main functional blocks: (1) power supplies and control and (2) laser drivers. These functions will be described in more detail below in view of FIG. 9.

Power Supplies and Control.

Microcontroller: The microcontroller (CPU) 5 is, for example, a Texas Instruments MSP430F437 16-bit microcontroller using a clock frequency of 32.768 kHz. The controller has 32K of FLASH memory for program storage, 256 bytes of FLASH for data storage, and 1K of RAM. It has a set of six I/O ports, configurable through software. Some are configured for mixed I/O, others for fixed input or fixed output service, and others for ADC service.

The microcontroller 5 controls modulation of the laser outputs with the fiber ID data burst, as well as the unit output power. Unit firmware is stored in the microcontroller's FLASH program memory and is accessible via a JTAG port. A crystal 6 generates the 32.768 kHz clock. The microcontroller 5 can be programmed/reprogrammed in-circuit.

A/D Converter (Internal to Microcontroller): Two of the eight inputs to the 12-bit ADC are used to measure battery voltage and the laser driver supply voltage. A power control/low battery sense circuit 48 produces a battery sense signal. This battery sense signal is measured directly from the battery through a FET and a voltage divider/filter section. The +2 V dc supply 8 is measured from the supply through a voltage divider. The reference voltage input for the A/D can be derived from a +3.6 V dc supply 7 and includes two other selectable internal references: +2.5 Vdc and +1.5V dc reference 9. For the MFT, the internal +1.5 V dc reference 9 is used.

Keypad: An exemplary keypad consists of two user keys 11, 12 and five embedded LEDs 10, connected to the printed circuit board (PCB) via a 19-conductor flat flexible cable (FFC). The two user keys consist of Power switch 11 and Group select switch 12. The Power switch 11 cycles unit power on and off. The Group select switch 12 key is used to select the desired fiber ID group. The five embedded LEDs 10 are used to display MFT status. In this embodiment, they consist of ID 1-12, ID 13-24, ID 25-36, ID 37-48, and Low Battery.

Power Supplies. The power supplies of the MFT consist of two switching regulators, a linear regulator, and a buffered band-gap reference. The main switching regulator is a synchronous boost regulator that takes the +1.8 V dc to +3.4 V dc input and steps it up to +3.6 V dc. The regulator is capable of sourcing 300 mA as configured.

A laser drive switching regulator is a synchronous buck regulator that converts the +3.6 V dc main supply down to +2 V dc. The regulator is capable of sourcing 300 mA as configured.

The band-gap reference voltage is generated internally by the microcontroller 5. The selected output voltage is +1.5 V dc. The output is buffered by an op amp, which is configured for unity gain. The output of the buffer feeds the +1.5 V dc references on the laser driver circuit loops.

The linear regulator is used to drop the input from the AC adapter 13 (+6 V dc to +21 V dc) to +3.4 V dc, which keeps the input to the main switching regulator below its output voltage (+3.6 V dc).

Pressing the power key 11 with the unit off causes a low to be applied to the gates of four FETs, turning them on. Two of the FETs provide a low voltage drop polarity protection via the built in body diodes. The other two FETs connect the two AA battery 14 input to the main boost regulator. A 3.9 V Zener diode, along with two other FETs, act to limit the input battery voltage in the event that a 9 V transistor battery is inserted into the unit in place of the specified two AA batteries. Another FET shuts off the battery input when power is provided via an AC adapter. When battery voltage is applied to main switching regulator, it in turn supplies +3.6 V dc to the unit, causing a power up reset and turning on the microcontroller 5.

An alternate means of powering the unit is by connecting a nominal 9 V dc output (6V-21V) AC adapter 13. A full-wave rectifier allows any polarity of input while a PTC fuse and Zener diode provides protection against over-voltage. The linear regulator regulates the input to +3.4 V dc while an FET supplies a means of turning the unit on and off when an AC input is used. Another FET provides a means for the microcontroller 5 to detect the presence of the AC adapter.

The unit uses a single mode MPO 15, 12-fiber connector/adapter for the laser output port.

The Group select key is used to select which group of fiber ID's will be transmitted from the unit. Pressing this key cycles though the four groups: 1-12, 13-24, 25-36, and 37-48. The power key 11 will cycle unit power on and off. In this embodiment, the key must be pressed and held for 1 second to function properly. This prevents accidental activation/deactivation.

In this embodiment, the MFT runs from two 1.5 V dc alkaline batteries 14 or two 1.2 V NiMH batteries. The typical current draw is 100 mA@3 V dc input. The unit can also be run from an external AC adapter.

Laser Drivers. The PCB supports twelve lasers, with twelve individual drive circuits set up in six pairs (16, 17, 18, 19, 20 and 21), allowing the use of space saving multiple device packages. Each pair of drive circuits consist of a dual channel digital potentiometer, two op amps, three dual FETs, and half of a quad analog switch. It is not necessary to use six pairs; rather, twelve separate lasers/drivers could be used.

The op amp in each driver circuit is used to amplify the feedback current from a backfacet monitor diode in the laser. The non-inverting input is driven by a +1.5V reference voltage 9. The inverting input is driven by the feedback current from the backfacet monitor. The amount of signal from the monitor is adjusted by one channel of a digital potentiometer, which shunts a portion of that signal to ground and controls the output of the op amp.

The output of the op amp is coupled to a sample/hold and upper driver FET portion of the laser current driver circuit via one gate of an analog switch. This output biases the gate of the upper FET which in turn controls the operating current of the laser. The switch is controlled by the microcontroller 5. The microcontroller 5 also controls the lower driver FET, biasing the gate to turn the FET on and off. The upper and lower FETs comprise the drive current circuit for the laser.

An FET after the analog switch in the sample/hold portion of the driver circuit is used to disable the circuit. This FET is controlled via a combination of a 555 timer, a watchdog timer, and another FET (collectively laser watchdog timer 22). The power-up reset of the watchdog timer and the programmed time interval on the 555 timer work to provide an approximately 440 mS delay after the MFT power is applied. This delay allows the power supplies to stabilize, the microcontroller 5 to finish its start up routine and to program the stored calibration values into the digital potentiometers. This prevents accidental activation of the laser drive circuits until all of these functions have been completed.

The watchdog timer receives a periodic reset pulse from the microcontroller 5. If the microcontroller fails or hangs up, the watchdog timer will not be reset and it will trip approximately 1.6 seconds after it stops receiving reset pulses. This forces and holds the 555 timer into a reset condition. This in turn shuts down all twelve laser drive circuits, preventing the unsafe operation of the lasers.

Laser drive current in each circuit is limited by a parallel pair of 20-ohm resistors on the low side of the laser diode. This limits the maximum laser current to 90 mA.

The laser assembly consists of a daughter PCB, a multi-laser mounting block, and a twelve laser-to-MPO optical assembly. The laser assembly connects to the main PCB on the daughter PCB to the main PCB.

Multifiber Identifier. The MFI 3 is designed to detect the presence of digitally coded laser light in optical fibers or optical fiber ribbons such as those used in FTTx deployments.

In this embodiment, the unit is activated by inserting the ribbon or fiber under test into a channel 49 in the head end of a optical fiber identifier. Next, a trigger 23, located on the underside of the MFI 3 (not shown), is pulled which causes the head 50 to press the fiber or ribbon into close proximity to the photodiodes 32, 33, and create a controlled bend in the fiber or ribbon. The unit has one LED 41 and an LCD 24 on the front to indicate, No ID, or the detected ID, respectively. There is an audible tone generator 40 that ‘beeps’ briefly when the unit is energized and is beeps once every half-second when a valid digital code is detected. The LCD 24 displays the fiber identification number (1-48).

The MFI 3 is used in conjunction with the MFT 1. It detects the digitally coded data bursts transmitted by the MFT 1 when the MFI 3 is clamped on the ribbon or fiber under test. Below is on embodiment of the protocol used by the MFT 1 and MFI 3 for identifying fibers.

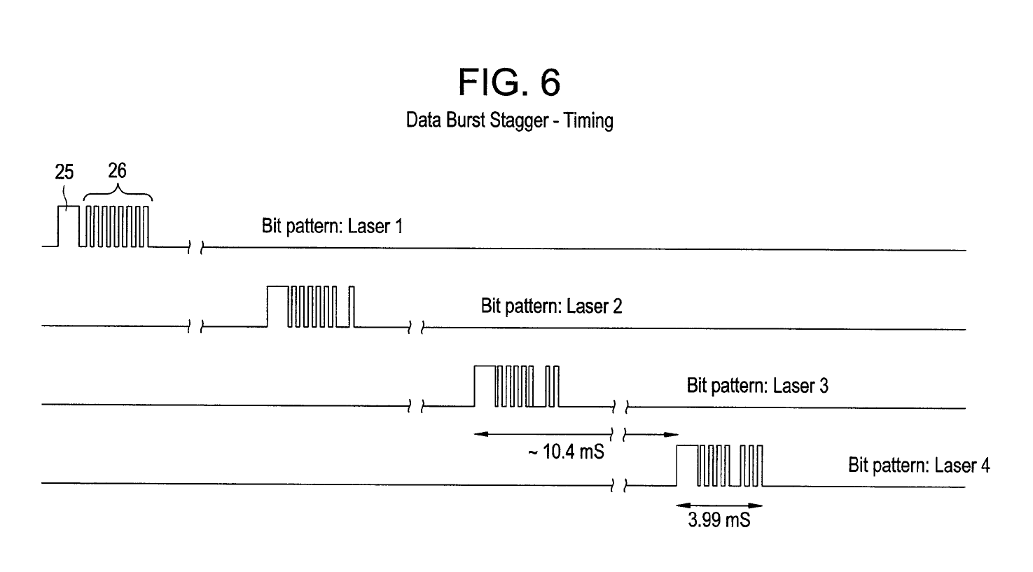

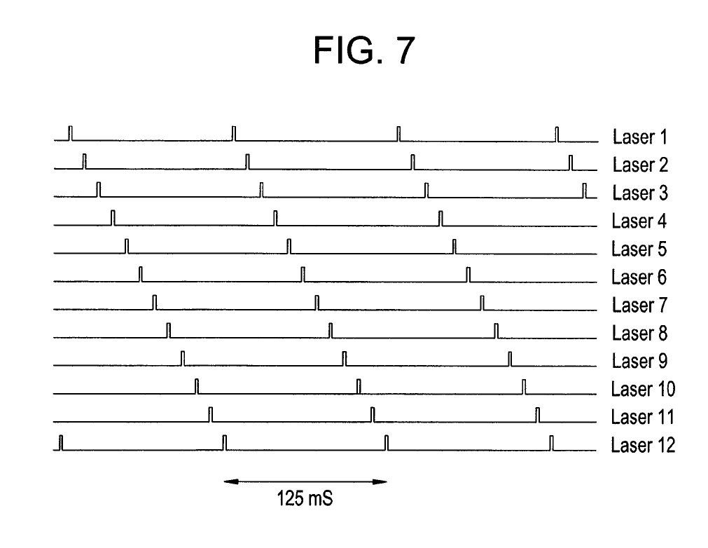

As shown in FIG. 6, which shows an example of the data burst stagger timing for four lasers, the ID data burst consists of a start bit 25, followed by 8 bits 26 configured to provide up to 48 individual fiber ID codes. The 8 data bits are configured using the RZ (Return to Zero) format. The MSB and LSB will always be logic ‘1’. The data burst on each individual fiber will repeat 8 times per second. Each bit is approximately 420 μS wide (2.38 KHz rate). A logic “1” is high for 210 μs and low 210 μs. A logic “0” is low for 420 μS.

The start bit 25 is approximately 840 μS wide (630 μS high and 210 μS low) and precedes 8-bit ID code 26. The total data burst width is 3990 μS (3.990 mS).

In this embodiment, the MFI 3 must detect two valid sequential ID codes before it will display the fiber ID.

| | | |
|---|---|---|
| Fiber # | ID Data | Bit Pattern |

Group 1 (1-12)

| | | |
|---|---|---|
| 1 | 0xFF | 11111111 |
| 2 | 0xFD | 11111101 |
| 3 | 0xFB | 11111011 |
| 4 | 0xF7 | 11110111 |
| 5 | 0xEF | 11101111 |
| 6 | 0xDF | 11011111 |
| 7 | 0xBF | 10111111 |
| 8 | 0xF9 | 11111001 |
| 9 | 0xF3 | 11110011 |
| 10 | 0xE7 | 11100111 |
| 11 | 0xCF | 11001111 |
| 12 | 0x9F | 10011111 |

| | | |
|---|---|---|
| Fiber # | ID Data | Bit Pattern |

Group 2 (13-24)

| | | |
|---|---|---|
| 13 | 0xF5 | 11110101 |
| 14 | 0xED | 11101101 |
| 15 | 0xDD | 11011101 |
| 16 | 0xBD | 10111101 |
| 17 | 0xEB | 11101011 |
| 18 | 0xDB | 11011011 |
| 19 | 0xBB | 10111011 |
| 20 | 0xD7 | 11010111 |
| 21 | 0xB7 | 10110111 |
| 22 | 0xAF | 10101111 |
| 23 | 0x71 | 11110001 |
| 24 | 0xE3 | 11100011 |

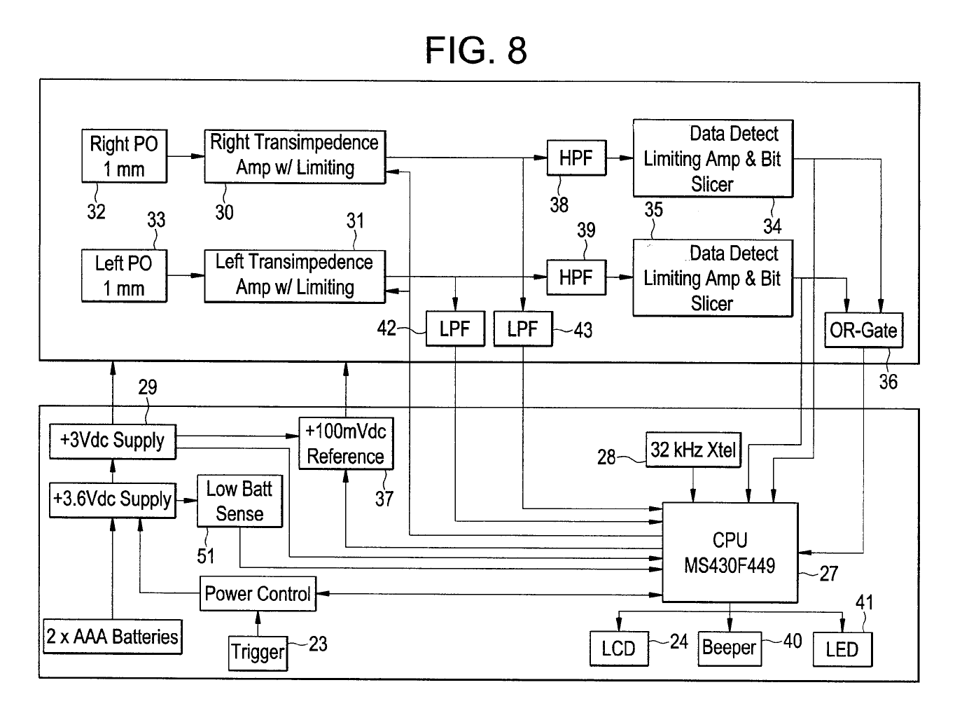

The MFI 3 consists of five main functional blocks: (1) I/O and control; (2) Optics; (3) Transimpedance Amplifiers; (4) Data Detector; and (5) Power Supplies. These functions will be described in detail below in view of FIG. 8.

I/O and Control. The I/O and Control circuits consist of a microcontroller 27, a keypad (not shown), and an LCD 24 to display measurement results.

Microcontroller. The microcontroller 27 is, for example, a Texas Instruments MSP430F449 16-bit microcontroller using a clock frequency of 32.768 kHz. A 32 kHz crystal 28 generates the clock.

The microcontroller 27 has a set of six I/O ports, configurable through software. Some are configured for mixed I/O, others for fixed input or fixed output service. One set of 44 single/multi-purpose I/O pins drive the LCD 24.

A/D converter (internal to microcontroller). Two of the eight inputs to a 12-bit A/D are used to measure battery voltage and base reference voltage. A low battery sense circuit 51 produces a BATT SENSE signal. The reference voltage input for the A/D is derived from a +3V dc Supply 29 and includes two other selectable internal references: +2.5 V dc and +1.5 V dc.

A BATT SENSE A/D input on the microcontroller 5 is used as a low battery detector, set to trigger the Low Batt indicator LED when the battery voltage reaches ˜+2.0 Vdc.

Two other of the eight inputs to the 12-bit A/D are used to measure the output from the Right and Left Transimpedance Amps 30, 31 for the purpose of measuring the offsets.

Keypad. In this embodiment, the keypad is connected to the main printed circuit board (PCB) through a 10-conductor flat flexible cable (FFC).

Transimpedance Amplifiers. The Right and Left Transimpedance Amps w/Limiting (TIA) 30, 31 include an op amp, low leakage analog switches, and associated gain resistors and compensation capacitors. There are gain stages to each TIA. Each TIA input is derived from one of two photodiodes (or detectors) 32, 33 mounted in the optics. Maximum gain for the TIAs is 100 million. However, only a single gain stage is used for multi-fiber identification. A pair of limiting diodes is also switched into the circuit to prevent the amplifiers from saturating. The outputs feed the Data Detect Limiting Amp & Bit Slicer circuits 34, 35. The outputs of the TIAs 30, 31 are also pass through two low pass filters 42, 43 to the microcontroller 5, for further processing. The transimpedance gain in this embodiment is 1.65M.

Optics. The MFI optics include two 1 mm InGaAs photo diodes (detectors) (Right PD 1 mm 32 and Left PD 1 mm 33) with ball lenses, installed into a prism mount. The mount positions a prism made from an optical grade plastic. This assembly is held into position and mounts to the PCB via two more pieces, which complete the optical head. The photo diodes 32, 33 will see an input range of approximately +11 dBm to −70 dBm (˜+23 to −58 dBm core power in the fiber under test when using 1550 nm).

Data Discriminator. The Data Detect Limiting Amp & Bit Slicer circuits 34, 35 include op amps which are AC coupled to the TIA outputs through high pass filters 38, 39. The op amps are buffer amplifiers with a gain of 10. The gain is diode limited to prevent the output from reaching the upper power supply rail. The outputs of the buffer amplifiers and diode limiter feed two comparators that are configured as bit-slicers to recover the coded data from the ribbon/fiber under test. The bit-slicer outputs are connected to inputs on the microcontroller 27. The bit-slicer outputs also drive the inputs of an OR-gate 36, the output of which feeds the microcontroller 27. This input pin is configured as an external interrupt.

The switching threshold voltage for the comparators is derived from the +100 mV dc Reference 37.

Power Supply. The power supply includes a switching boost converter, a LDO linear regulator, and a buffered band-gap reference. The switching boost converter is activated when the POWER button on the keypad is depressed or the trigger is pulled, which pulls the gate of a PFET low, which in turn applies battery power to pins the switching boost converter, enabling the boost converter. Once the microcontroller 27 has reset and is running, it holds the gate of the PFET low.

The LDO linear regulator is used as a post-regulator/filter to create a clean low-noise +3.1 V for the analog front ends, tone/data detect circuits, the microcontroller, and the internal A/D converter on the microcontroller.

The band-gap reference voltage is generated internally by the microcontroller 27. The selected output voltage is +2.5 V dc. The output goes through a voltage divider/filter which divides the output by a factor of 25. The output from the voltage divider is buffered by an op amp, which is configured for unity gain. The output of the buffer feeds the +100 mV dc Reference 37 on the transimpedance amplifiers and provides the switching threshold inputs for the bit slicing comparators used for data/tone recovery.

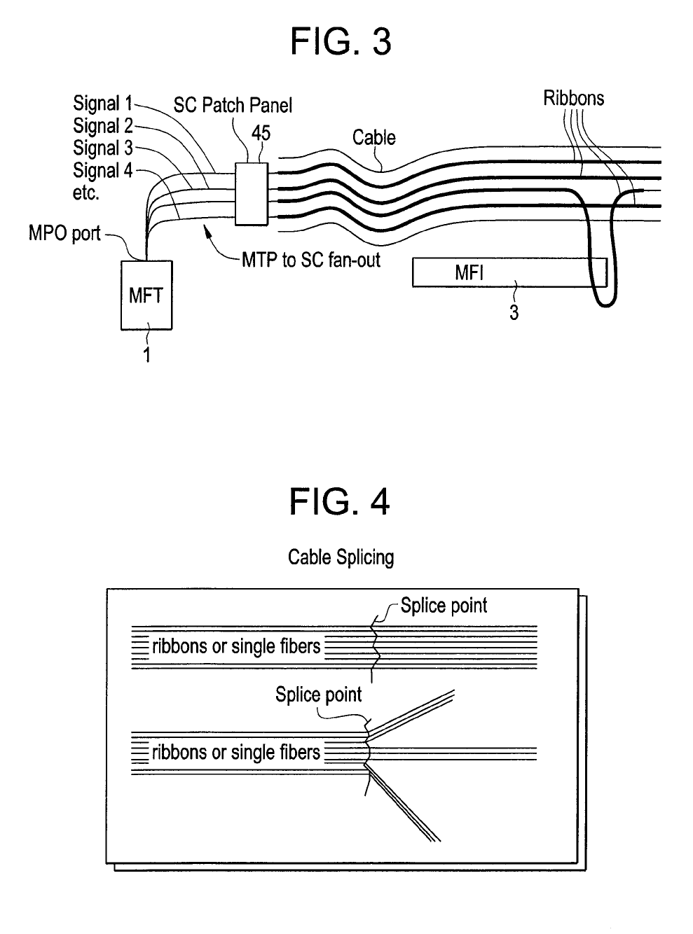

Next, a method of using the MFT 1 and MFI 3 will be described in connection with FIGS. 3 and 4. To identify fibers in a cable to be spliced to the next cable section (for example, the top cable in FIG. 4), or fibers in a through cable to be spliced to smaller branch cables (for example, bottom cable in FIG. 4), the MFT 1 would be set up at the termination of the cable, for example at a central office optical patch panel 45. In the case of a single-fiber cable, each fiber to be identified would be connected to a single-fiber output of the MFT 1. In the case of a ribbon cable, one fiber in each ribbon would be connected to a single-fiber output of the MFT 1. Thus, an MFT with a twelve fiber connector 46, and a twelve fiber fan-out 2, could be used to identify twelve single fibers or twelve ribbon fibers.

At the splice location, for example at a mid-span meeting point of two cable sections, or the point where a branch cable is to be spliced to a through cable, the outer sheath of the cable would be removed to access individual fibers or ribbons. Target fibers, or ribbons, would typically be located using fiber and binder (group) colors and then ‘identified’ by applying the MFI 3 and confirming that the number displayed by the MFI 3 corresponds to the output of the MFT 1 that should be connected to the target fiber.

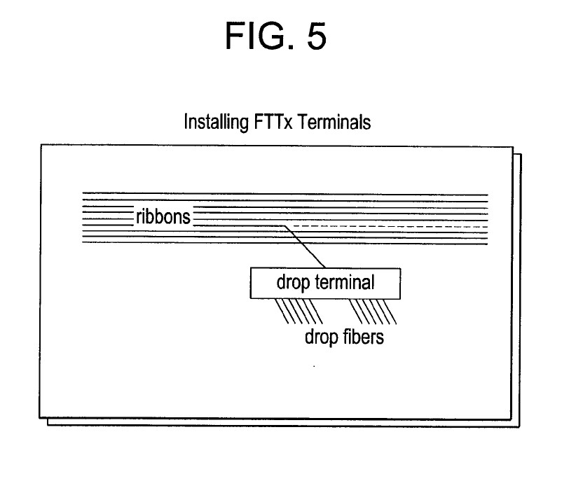

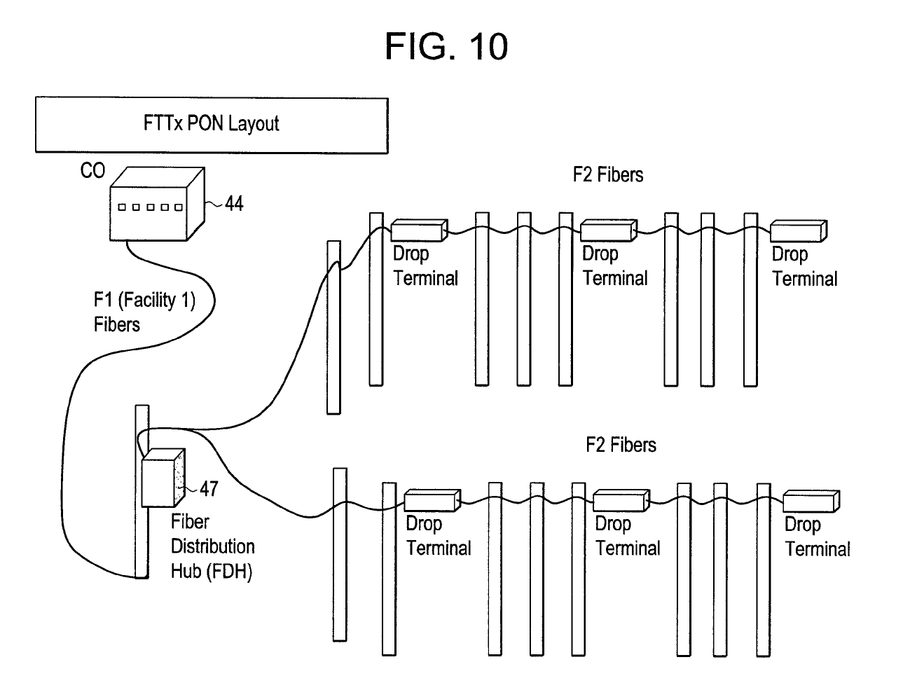

As shown in FIGS. 5 and 10, to identify customer or ‘F2’ fibers in a fiber-to-the-home (FTTH) network to be spliced to a connectorized pigtail at a terminal, or to a customer drop cable at a pedestal, the MFT 1 would be set up at a fiber distribution hub (FDH) 47. Single-fiber outputs of the MFT would be connected to the ports on the F2 distribution panel in the FDH that terminate the target fibers. The MFI 3 would be used at the terminal or pedestal to identify fibers before they are cut and spliced.

The MFT and MFI may also be used by FTTH installers in the reverse direction to confirm connections from a terminal back to the FDH. In this application the MFT 1 is connected to ports on the terminal and the MFI 3 is applied to splitter pigtails at the FDH 47, or to an unconnected jumper or pigtail (half a jumper) connected by the technician at the FDH 47 to F2 ports before splitter pigtails are connected.

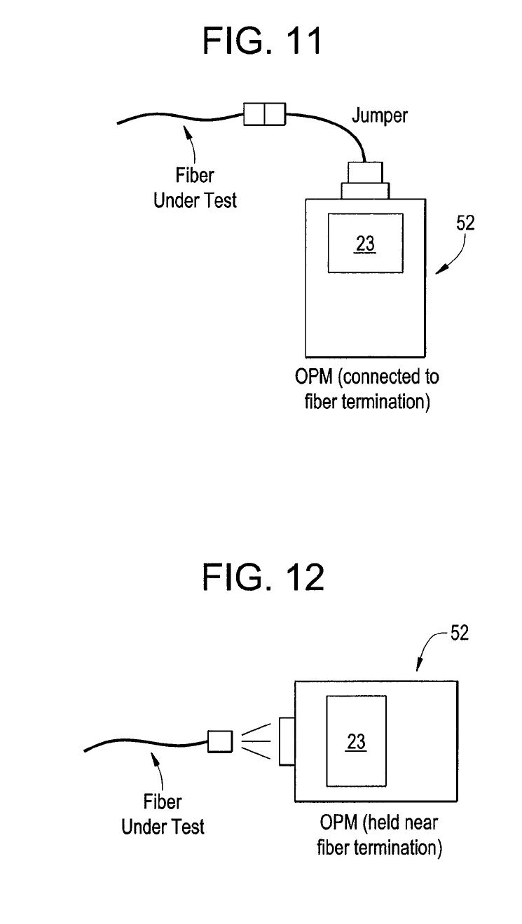

The MFT may also be used with an optical detector device, for example, an optical power meter or OPM equipped with ID code detection circuits equivalent to those defined for the MFI 3. In this application, as in the MFI application, one or more outputs of the MFT will be connected at the near-end to one or multiple fibers at a central office optical patch panel, FTTH FDH, or equivalent fiber termination point. See for example, OPMs 52 in FIGS. 11 and 12. OPMs may then be used at the corresponding far-end termination points of these fibers, typically at other optical patch panels or FTTH drop terminals. The OPMs may be connected to each fiber to be identified using a jumper, or held in close proximity to the termination (port) of each fiber to be identified. In both cases the OPM can indicate that no code is detected, or display any detected fiber identification code. End-to-end fiber identification is useful when trying to find corresponding ports on patch panels or terminals at either end of a point-to-point, or point-to-multipoint (branched), fiber optic cable, or multi-cable route, comprising multiple fiber optic fibers or ribbons.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of identifying one of a plurality of fiber optic fibers comprising:
transmitting a plurality of fiber identification data signals into ends of a plurality of fiber optic fibers, wherein a different data signal is transmitted to each of said plurality of fiber optic fibers; and
identifying one of said plurality of fiber optic fibers based on said signal transmitted on said one fiber;
wherein said data signals are digital codes.

2. The method of claim 1, wherein said identification occurs at a controlled bend in said one of said plurality of fibers.

3. The method of claim 1, wherein said plurality of fibers are part of a fiber optic cable.

4. The method of claim 1, wherein said data signals are transmitted in return to zero format.

5. The method of claim 1, wherein said data signals are transmitted into said plurality of fibers one at a time.

6. The method of claim 1, wherein said identification occurs at a termination point of said one of said plurality of fibers.

7. A method of identifying one of a plurality of fiber optic ribbons comprising:
transmitting a plurality of fiber identification data signals into ends of one fiber in each of said plurality of fiber optic ribbons, wherein a different data signal is transmitted to said one fiber in each of said plurality of fiber optic ribbons; and
identifying one of said plurality of fiber optic ribbons based on said signal transmitted on said one fiber;
wherein said data signals are digital codes.

8. The method of claim 7, wherein said identification occurs at a controlled bend in said one of said plurality of ribbons.

9. The method of claim 7, wherein said data signals are transmitted in return to zero format.

10. The method of claim 7, wherein said data signals are transmitted into said one fiber in said plurality of ribbons one at a time.

11. The method of claim 7, wherein said identification occurs at a termination point of said one of said plurality of ribbons.
